(19) United States
(12) Patent Application Publication
(10) Pub. No.: US 2006/0090612 A1
(43) Pub. Date: May 4, 2006

(54) Socket specification identification

(76) Inventor: Ying-Hao Peng, Tanzih Township (TW)

Correspondence Address: NIKOLAI & MERSEREAU, P.A., 900 SECOND AVENUE SOUTH, SUITE 820, MINNEAPOLIS, MN, 55402, US

(21) Appl. No.: 11/311,746

(22) Filed: Dec. 19, 2005

Related U.S. Application Data
(62) Division of application No. 10/694,662, filed on Oct. 28, 2003, now Pat. No. 7,010,998.

(30) Foreign Application Priority Data
Jan. 24, 2003 (TW) 092101765

(51) Int. Cl. B25B 13/06

(52) U.S. Cl. 81/121.1

(57) ABSTRACT

A socket includes a dark surface defined in an outer surface thereof and a specification is engraved in the dark surface and electro-plated with an anti-rusting light color layer which is clearly seen. The dark surface is treated by manganous phosphate and coated with a transparent protection layer.

### FIELD OF THE INVENTION

The present invention relates to a socket specification identification which includes a dark outer surface and engraved digits with an electroplating layer which has light color and can be seen clearly.

### BACKGROUND OF THE INVENTION

A conventional socket 50 is shown in FIG. 3 and generally includes a first section 51 and a second section 52 which has a larger diameter than the first section 51. A through passage 53 is defined axially through the socket 50. The specification 54 of the socket 50 is engraved in the outer surface of the second section 52 and the socket 50 is electro-plated with an anti-rusting layer 60 which covers the outer surface of the first and second sections 51, 52 and the inner periphery of the through passage 53. The specification 54 is also electro-plated with the anti-rusting layer 60 so that the specification 54 is not obvious because of the same anti-rusting layer which is generally silver in color. The unobvious specification 54 is required to be improved for a long time. Another way to put the specification is to print the specification on the outer surface of the socket by a color that is different from the color of the outer surface of the socket. Nevertheless, the printed specification can be removed or fades away by friction after a period of time of use.

The present invention intends to provide a socket specification identification which is electro-plated with a light color of anti-rusting layer and the outer surface of the socket is treated to be in dark color so that the specification can be seen among the dark background.

### SUMMARY OF THE INVENTION

The present invention relates to a socket that includes a tubular body with a dark surface defined in an outer surface thereof and a specification is engraved in the dark surface and electroplated with an anti-rusting light color layer. The specification can be easily and clearly seen among the dark surface.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the socket of the present invention;

FIG. 2 is a cross sectional view to show the socket of the present invention;

FIG. 2-1 shows a bottom cross sectional view along D-D in FIG. 2 of the socket of the present invention, and

FIG. 3 is a cross sectional view to show a conventional socket.

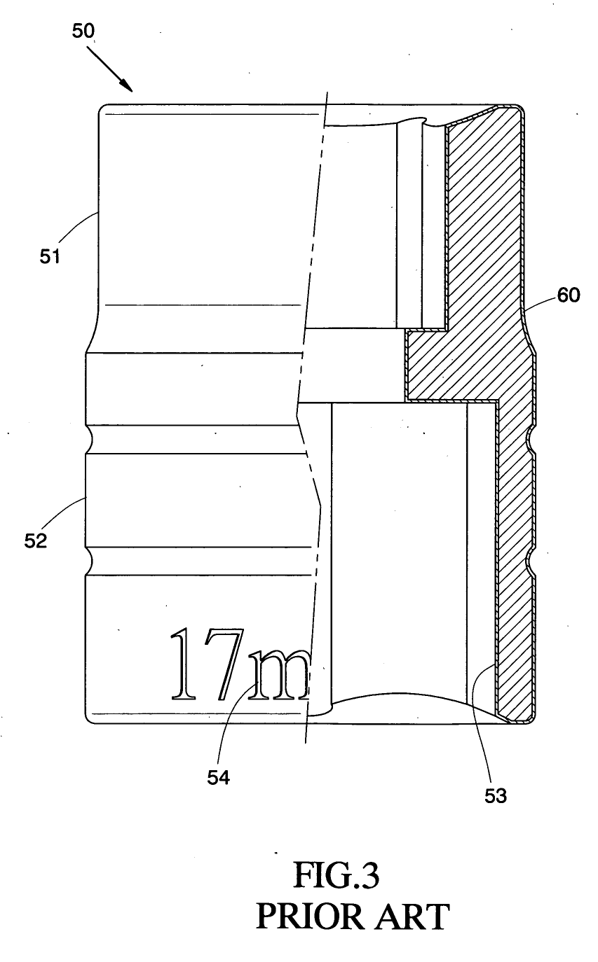

### DETAILED DESCRIPTION OF THE PREFERRED EMBODIMENT

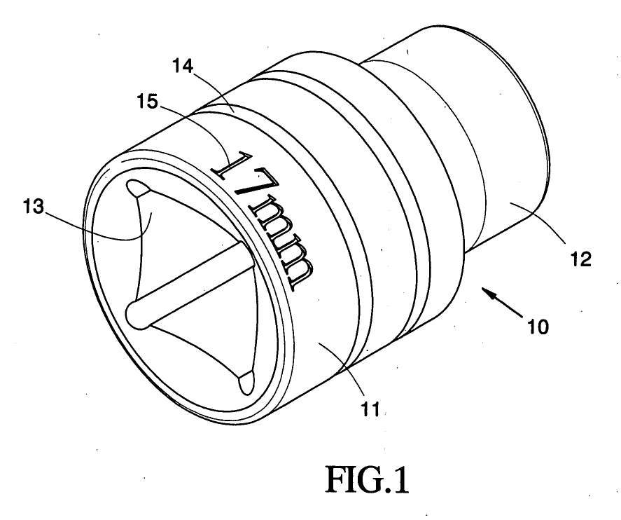

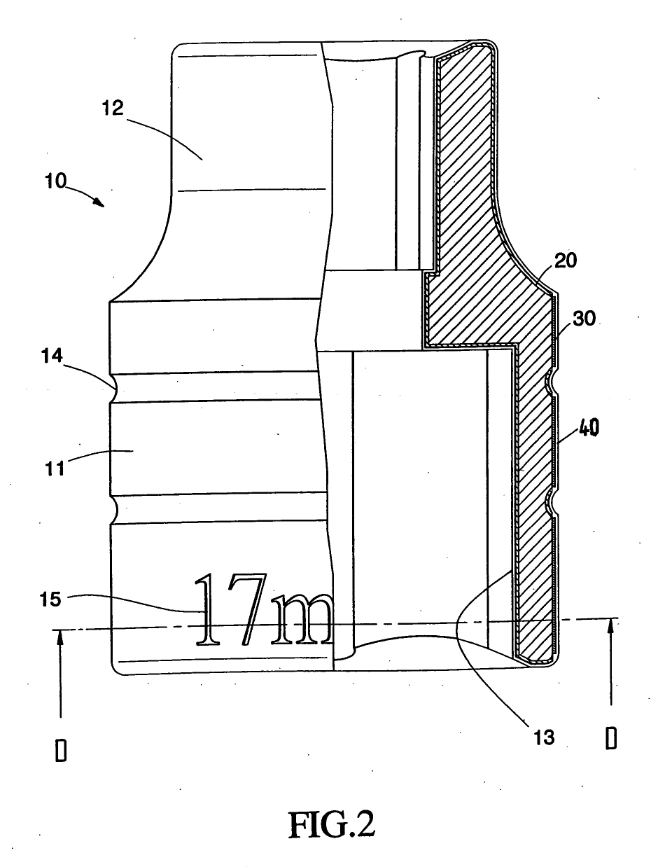

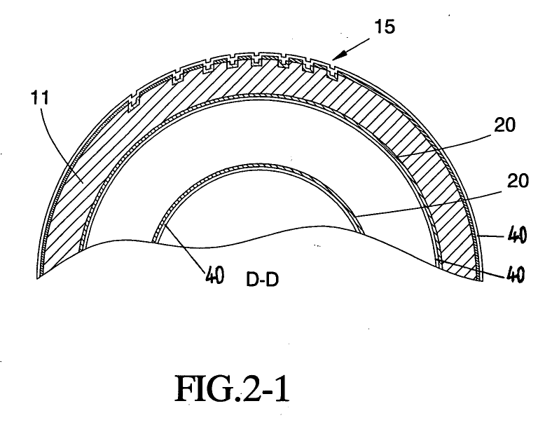

Referring to FIGS. 1, 2 and 2-1, the socket 10 of the present invention comprises a tubular body which includes a first section 11 and a second section 12 which has a diameter smaller than a diameter of the first section 11. Two grooves 14 are defined in the first section 11. A through passage 13 is defined axially through the socket 10. A specification 15 is engraved in the outer surface of the first section 11.

The socket 10 is electro-plated with an anti-rusting layer 20 which covers the outer surface of the socket 10, the engraved specification 15 and the inner periphery of the through passage 13.

The anti-rusting layer 20 on the first section 11 is removed except for the specification 15 and the first section 11 is then treated by manganous phosphate to form a dark surface 30 in an outer surface of the first section 11 of the tubular body, while the anti-rusting layer 20 on the specification 15 is maintained. A transparent protection layer 40 is coated on the dark surface 30 and the inner periphery of the through passage 13.

The socket 10 includes a dark first section 11 with a bright engraved specification 15 so that the engrave specification 15 can be clearly seen among the dark surface 30.

While we have shown and described the embodiment in accordance with the present invention, it should be clear to those skilled in the art that further embodiments may be made without departing from the scope of the present invention.

What is claimed is:

1. A socket comprising:
a tubular body and a dark surface defined in an outer surface of the tubular body, and
a specification being engraved in the dark surface and electroplated with an anti-rusting light color layer.

2. The socket as claimed in claim 1, wherein the tubular body includes a first section and a second section which has a diameter smaller than a diameter of the first section, the dark surface and the specification are defined in the first section.

3. The socket as claimed in claim 2, wherein at least one groove is defined in the first section.

4. The socket as claimed in claim 1, wherein a transparent protection layer is coated on the dark surface.

5. The socket as claimed in claim 1, wherein the dark surface is treated by manganous phosphate.
